(19) United States
(12) Patent Application Publication
(10) Pub. No.: US 2011/0251826 A1
(43) Pub. Date: Oct. 13, 2011

(54) Data Analyzer

(76) Inventor: Gerard McGoogan, Philpston (GB)

(21) Appl. No.: 13/123,966

(22) PCT Filed: Oct. 14, 2009
(86) PCT No.: PCT/EP2009/007372

§ 371 Date: Jul. 1, 2011

Related U.S. Application Data
(60) Provisional application No. 61/196,058, filed on Oct. 14, 2008.

(51) Int. Cl. G06F 15/00

(52) U.S. Cl. 702/189

(57) ABSTRACT

The present invention relates to an off-line signal analyzer comprising a digital signal processor (8) configured to perform digital processing on a signal comprising data derived from a sensor input (1). The sensor may, for example, be an accelerometer mounted to a rolling element bearing for detecting bearing vibration. According to the invention, the analyzer comprises a digital to analogue converter (11) for supplying an analogue output, derived from the digital signal processor (8), to an analogue device such as headphones (10).

### TECHNICAL FIELD

This invention relates to data collectors/analyzers, particularly for in-situ analysis and/or diagnosis of the conditions of bearings. More particularly, the present invention relates to off-line vibrational bearing analyzers which comprise digital signal processing.

### BACKGROUND

Vibrations measured by bearing testers or analyzers, for example while a machine is in operation and/or when a machine is subjected to a controlled external excitation, provide an indication of bearing conditions and/or lubrication conditions and/or other mechanical conditions. This may be used to detect abnormalities, plan preventive maintenance and avoid bearing failure. Some vibrational analysis systems comprise a network of sensors which are permanently installed on a plurality of machines and which provide data to a central processor on a continuous or periodic basis. On the other hand, the vibrational analyzers of the present invention are off-line analyzers, that is to say they are devices which a maintenance engineer will take sequentially to each machine which he wishes to analyse. Such off-line analyzers are generally hand-held and generally incorporate or are connectable to one or more sensors, and have processing means for analysing the signal from the sensor and a display. They often permit the collection/recording of data for subsequent downloading to a separate computer system. They are also sometimes called portable data collectors.

The inventors have perceived that off-line data collectors/analyzers and in particular vibration bearing analyzers with configurations in which demodulation and/or filtering of a signal derived from an analogue sensor are performed, may be improved and/or provided with improved functionality.

### SUMMARY OF THE INVENTION

According to one of its aspects, the present invention provides an off-line signal analyzer comprising an analogue to digital converter (ADC). The ADC converts analogue input signals to digital signals. The analogue input signals comprise a phase. The analyzer also comprises a digital signal processor (DSP) configured to perform digital processing on the digital signals from the ADC. According to the invention the signal analyzer comprises a digital to analogue converter (DAC) configured to provide an analogue output signal derived from the DSP to an output.

Preferably the DAC is synchronized with the ADC at least with respect to the signal phase. Suitably the ADC and the DAC have a common control clock, that is they are clocked by the same clock signal and are thus synchronized. To fully control the signal processing, it is advantageous if also the DSP has a common control clock with the ADC and/or the DAC.

Preferably one of the ADC, the DAC, or the DSP is a control clock master, that is generating the control clock signals, and the others are control clock slaves, that is just receiving the control clock signals from the control clock master.

According to another one of its aspects, the present invention provides an off-line analyzer comprising a digital signal processor configured to perform digital processing on a signal comprising bearing vibration data derived from a sensor input. According to the invention the bearing analyzer comprises a digital to analogue converter configured to provide an analogue signal to an output, the analogue signal being derived from the digital signal processor. The digital signal processor will typically perform digital filtering and digital demodulation as part of the digital signal processing.

The output may provide a real time output, that is to say an output which is configured to be contemporaneous with the input to the vibrational analyzer (for example from a sensor) as opposed, for example, to an output which is stored by the vibrational analyzer for subsequent downloading when data collection has been completed. There may be a time delay between the input to the vibrational analyzer and the real time output; this may be up to a few seconds, for example up to 2 or 3 seconds.

The output may be an external output, that is to say an output configured to provide a signal to an external or peripheral device. The term “peripheral device” is intended to denote a device that may be connected to the vibrational analyzer but which is distinct from the components which are integral with the vibrational analyzer. The components which are integral with the vibrational analyzer include, for example, integral sensors, integral displays (for example an integral screen), integral data processors and integral data storage devices (for example a memory or memory card which may be removable).

The output may be a multifunctional external output, where the multifunctional output is configured to provide an output signal to at least two different devices. For example, it may be configured to provide a signal to headphones and to provide a signal to a strobe. In some embodiments, the multifunctional external output provides a signal to one device at a time. For example, headphones could be connected to the multifunctional external output at one time and subsequently disconnected to enable connection of a strobe.

Preferably, the multifunctional output is configured such that it may be connected simultaneously to at least two devices, for example such that it can simultaneously provide an output signal to at least two devices, for example to headphones and a strobe.

According to the invention the multifunctional external output is configured to transmit an analogue signal, the analogue signal will be derived from a digital output of the digital signal processor via a digital to analogue converter.

It will be appreciated that a vibrational analyzer according to the present invention may be used to analyze the condition of other components, for example gears, in addition to bearings.

### BRIEF DESCRIPTION OF THE DRAWINGS

Embodiments of the invention will now be described, by way of example only, with reference to the accompanying drawings of which:

FIGS. 1a-1b are block diagrams illustrating components which may be included in and possible configurations for vibrational bearing analyzer,

FIG. 2 illustrates a block diagram of an analyzer comprising digital filtering and demodulation,

FIGS. 3-11 illustrate block diagrams of particular embodiments of the present invention.

### DETAILED DESCRIPTION

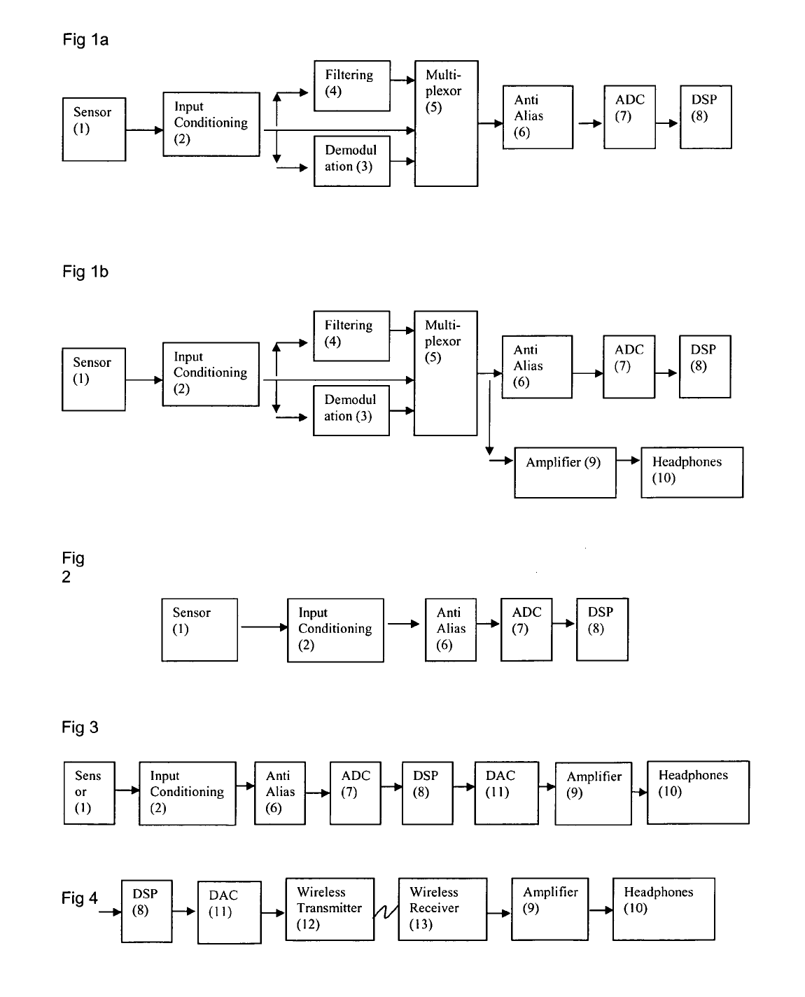

Off-line vibrational analyzers in accordance with the invention may comprise components illustrated with reference to FIG. 1a and FIG. 1b. These figures illustrate possible configurations of off-line vibrational analyzers which combine some or all of the following features:
(1) A sensor 1, for example an accelerometer, that measures a parameter that relates to the condition of the machine that is being examined.
(2) Input conditioning 2; providing sensor power and gain if required.
(3) Demodulation 3, typically some form of band limiting filters followed by demodulation (examples are enveloping, GSe). This may also include demodulating signals that are ultrasonic (SEE or Acoustic emissions).
(4) Filtering 4 to remove spurious out of band signals or time domain integration.
(5) A multiplexor 5 to select straight, filtered or demodulated paths.
(6) Anti-alias filter 6 for removal of out of band signals.
(7) An analogue to digital converter (ADC) 7 to convert an analogue signal into digital representation.
(8) A digital signal processor (DSP) 8 to perform digital processing, for example FFT.

In addition to the above mentioned features, analyzers will traditionally comprise some kind of user input, such as keys and switches to make selections, and also output(s), such as displays and lights/indicators to give feedback and results to a user. These features are not illustrated.

In off-line vibrational analyzers which use digital signal processing 8, an analogue signal derived from a sensor 1 is converted to a digital signal for treatment by the digital signal processor 8. In configurations similar to that of FIG. 1a, filtering 4 and/or demodulation 3 of a signal from the sensor 1 is performed on the analogue signal prior to its conversion to a digital signal. Signal processing is performed at least partly in the analogue domain.

It is often useful and helpful for maintenance engineers to listen to machines being analysed so as to perceive vibrational characteristics. The previous practice of using a screwdriver pressed against the machine and held to the ear of the user to listen to a running machine is now rarely used due, notably, to health and safety considerations (the proximity of the user's head to rotating machinery and/or the use of ear defenders). In addition, the quality and information that can be detected with such a method is less than optimal.

FIG. 1b shows a configuration which may be used to provide a listening function to a configuration similar to that illustrated in FIG. 1a using:
(9) Amplifier 9 to boost output from the analogue signal path to levels required to drive a headphone.
(10) Headphones 10 for a user to listen into the analogue signal.

Such a support for connecting a headphone 10 is a beneficial feature. In the FIG. 1b set-up the user may for example be able to select whether to listen to a raw, unfiltered signal, a filtered signal or to the demodulated signal depending on the condition of the machine and personal preference. What is listened to is a live signal and the user can correlate this to the processed signal on the display. This is a radical improvement on using a screwdriver. The headphones 10 might be integrated into hearing protectors. In an attempt to reduce costs in such vibrational analyzers, traditionally only one channel may be made available and/or not all filter paths may be accessible and/or the headphones may for example have a fixed gain.

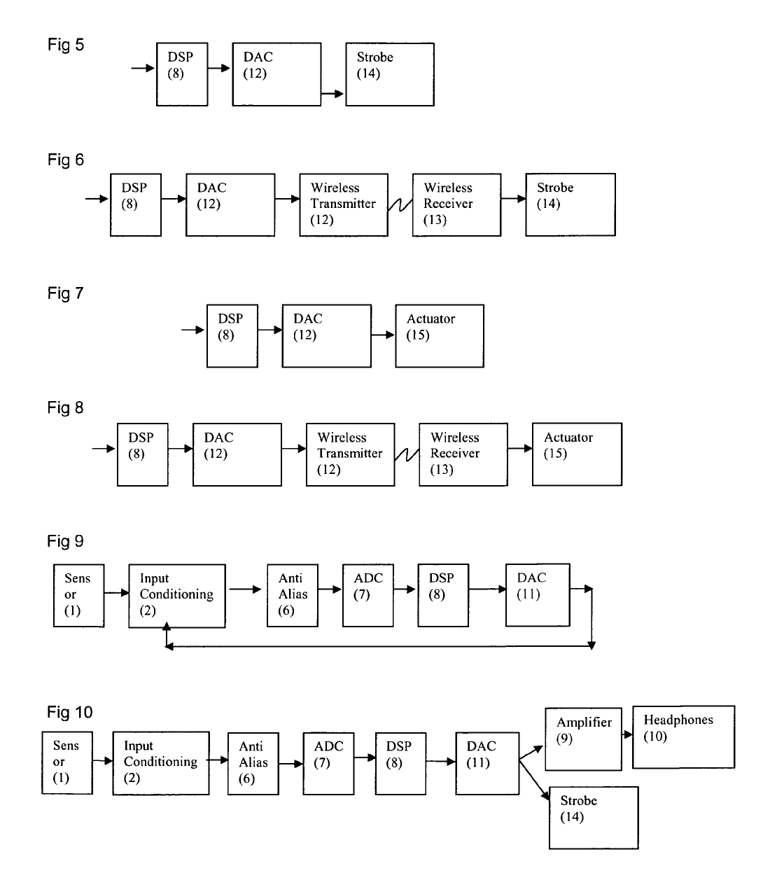

There is an attempt to move more and more into the digital domain. FIG. 2 shows an example of a configuration similar to that of FIG. 1a, but with the difference that demodulation and/or filtering functions are performed in the digital domain. This may increase linearity and/or reduce costs. It also allows a greater flexibility as software controlled functionality can be tuned/improved, added and/or deleted without changing any hardware.

Considering a configuration similar to that of FIG. 2, unlike that of the FIG. 1a configuration, it is no longer possible to tap off a demodulated and/or filtered signal and feed this to an amplifier 9 and subsequently to headphones 10. As it is important to keep the same phase of the input signal to both headphones and further digital processing, attempts could be made to add a headphone feature to such units by adding analogue filters before a headphone amplifier, similar to the analogue section of FIG. 1b. However, this would be costly and unwieldy and could lead to confusion if the headphones are listening to a different signal than is being collected/displayed by the unit.

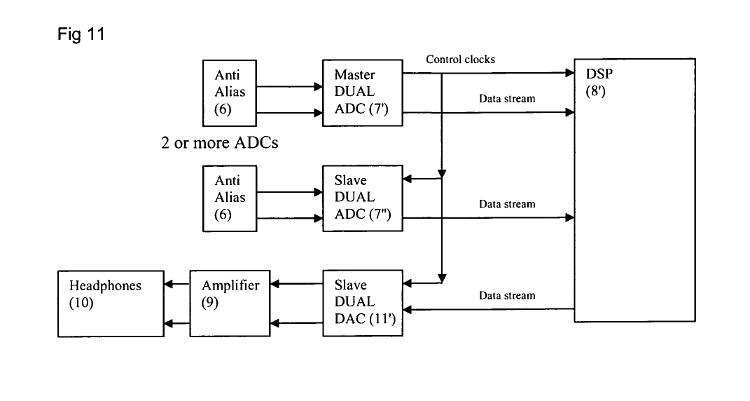

According to the invention this problem is solved by configuring a digital to analogue converter (DAC) directly connected to the DSP. As can be seen in a first embodiment of the invention in FIG. 3, a headphone function is created by feeding the digital processed signal from the DSP (digital signal processor) 8 to a DAC (digital to analogue converter) 11, suitably a dual-DAC for the possibility of stereo or just separate left/right output. In addition to the functions described above, this embodiment of an off-line signal comprises:
(11) A DAC 11, suitably a dual-DAC, driven from the DSP 8 with a digital stream representing, in this embodiment, a desired audio output which drives a headphone amplifier 9 and headphones 10.

The DSP 8 is provided with additional firmware to output the desired signal or stream of data. According to the invention the phase of the signal fed to the headphones is synchronized to that being received and processed by the DSP. This is made possible by synchronizing the ADC(s) 7 and the DAC(s) 11. Suitably, the ADC(s) and the DAC(s) have a common control clock, and to fully control the signal processing, it is advantageous if also the DSP 8 has a common control clock with the ADC 7 and/or the DAC 11.

Thus according to the invention, the DAC 11 provides an analogue signal derived from the digital signal processor 8 to an analogue device, e.g. headphones 10.

The digital data stream may for example represent one of the following:
1) The raw signal
2) A filtered signal. The shape and order of the filter are no longer constrained by the hardware present.
3) A filtered and demodulated signal. If required more than one implementation of demodulation can be included.

On multiple channel analyzers any channel may be easily selected. The signal may be attenuated and/or amplified in the digital domain. Different signals may be fed to the left and right ears of headphones. Ultrasonic and/or subsonic signals may be shifted into the audio range. The frequency response of the output digital stream may be customised to an individual, for example to compensate for hearing loss (not uncommon in maintenance engineers). Non measurement related audio, for example pre-recorded or stored signals, may be provided.

As the DSP 8 can generate multiple data streams concurrently, the invention may provide for the user to switch between multiple data streams; this may be achieved without having to wait on filter settling time.

The output of the vibrational analyzer may comprise a wireless transmitter configured to transmit the analogue signal to a peripheral device, for example to feed this signal to headphones or another listening device via a wireless link.

This could involve:
1) Sending it to wireless headphones
2) Sending the signal to another person for their opinion.

An embodiment showing this is illustrated in FIG. 4 and further comprises
(12) A wireless transmitter 12
(13) A wireless receiver 13 (which may suitably be part of a peripheral device)

Any device to which the output is connected may be detectable, for example by the device providing an identification signal back to the analyzer. This may provide information feedback to identify what peripheral device(s) is or are connected (e.g. headset, printer), and may be used to determine the nature of the output, for example to distinguish if audio, strobe trigger or a sweep signal should be provided as the output. Some systems, particularly wireless systems, work on profiles. That is, a new device broadcasts what profiles it supports, for example audio, serial, etc. Thus a vibrational analyzer in accordance with the invention may be configured to determine the appropriate type of output to be directed to a particular peripheral device.

The vibrational analyzer may have at least one output provided with an analogue signal derived from the digital signal processor. Preferably, this output or at least one additional output is a multifunctional output i.e. an output adapted to be connected to more than one type of device. It is thus possible to have a plurality of peripheral devices, for example headphones and a strobe, connectable to the same output (which may be a transmitter).

FIG. 5 illustrates an embodiment in which a multifunctional output (which may be a headphone output) is fed to a strobe 14. This may be configured:
1) To trigger a strobe based on the input analogue signal, for example one time.
2) To trigger a strobe based on a user input.
3) With a variable phase/frequency output so as to be able “freeze” a rotating part of e.g. a rolling element bearing at different rotational angles.
4) To trigger a high speed camera to take photographs of the machine for future analysis.

FIG. 6 illustrates an embodiment in which the link between the analyzer and the strobe 14 is a wireless link 12, 13.

The strobe 14 may be used to fire a pulse or series of pulses of light that “freezes” the rotation of a machine. If the strobe 14 is fired each time when for example a rotating part is in the same rotational position, then the rotating part will appear “frozen” (not rotating).

FIG. 7 and FIG. 8 illustrate further embodiments which may be used to provide a frequency response/transfer function of an object. The vibrational analyzer may output a signal that is used to excite an object such as a machine or structure under examination. In the embodiment of FIG. 7, a DAC 12 output is fed to an actuator 15, which is arranged to stimulate for example a structure to be analysed. The vibrational analyzer may sweep the output signal up and/or down in frequency to excite the actuator 15 and thus the structure being analysed at a desired frequency range or at a plurality of desired frequencies and measure the response by means of the sensor 1.

The vibrational analyzer may also output some form of band limited noise that can be used to measure the systems response.

FIG. 8 illustrates a similar arrangement in which an actuator 15 is linked to the vibrational analyzer by a wireless link 12, 13.

In the embodiments illustrated in FIGS. 4 to 8, it is to be understood that the input signal to the digital signal processor 8 is suitably derived from a series arrangement of a sensor 1, Input Conditioning 2, anti-alias filter 6, and analogue-to-digital converter 7 as shown in FIG. 3.

FIG. 9 illustrates an embodiment in which the output of a DAC 11 is fed back to the input of the unit, suitably directly to the input conditioning 2, for example to enable a check of the unit's operation, a self-test function. This feedback loop can be either internal or external to the analyzer. This self test mode may for example be combined with a demonstration mode. If an external feedback is used, i.e. a physical external wire is connected between the output and the sensor input, then this may be detected and the vibrational analyzer put automatically in a self test mode and possibly in addition in also a demonstration mode.

Where a headphone output is provided, the analyzer may suitably be arranged to be able to also playback pre-recorded signals/messages that can be used to prompt the user with for example an instruction guide. This may be useful:
1) When the user cannot see the unit's screen properly.
2) He does not wish to look at the screen (he wishes to concentrate on other factors, for example personal safety).
3) For entertainment, for example music.
4) For route instructions (what machines, where on the machines, where the machines are)

In a further embodiment of the invention, the output is a multifunctional external output configured so that it may provide a signal to at least two devices; a device may be disconnected to allow connection to the other of the at least two devices or the multifunctional external output may be connected to at least two devices at the same time. For example, as is illustrated in FIG. 10 embodiment the multifunctional external output is configured to provide a signal to both headphones 10 and a strobe 14. In this embodiment, either the headphones and/or the strobe may be connected to the multifunctional output, for example by being plugged in to a socket provided at the vibrational analyzer. The DAC can in some embodiments be of a dual type, providing two simultaneous outputs. In further embodiments, more than one DAC can be provided, for example two DACs of the dual type or one DAC of the dual type and one DAC of a single type.

FIG. 11 illustrates a configuration which may be used to implement certain embodiments of the invention with an in-phase multi-channel system. The introduction of the Pro Audio standard has brought to the market a number of fast (−200 kHz), low noise (24 Bit) and low cost ADCs/DACs from several companies. These devices are from a specification point of view suitable for noise and vibration measurement. The invention attains a known and synchronized phase relationship between ADC(s) and DAC(s), from input to output. The signals between the digital units must also be minimised to ensure that coupling from the analogue to the digital circuitry is minimised.

FIG. 11 illustrates an implementation of the invention by means of the control clocks such as frame/clock, left right clock and bit clock. As is illustrated, the embodiment according to FIG. 11 comprises two ADCs 7′, 7″ and one dual DAC 11′. According to this implementation, one of the ADCs 7′ is a master and the other ADC 7″, the DAC 11′ and the DSP 8′ are control clock slaves. This means that all the digital units and the converters are synchronized by the same control clock originating from one source. This enables full control of the phase from input to output. Once again, it is to be understood that the input to the two anti-alias filters 6 is derived from two separate sensors (not shown) after signal conditioning (not shown).

Alternatively to what is shown in FIG. 11, the DSP can be the control clock master and all the ADCs and the DACs are slaves, or one of the DACs is a control clock master and the DSP, all the ADCs and the other DACs are control clock slaves.

Any feature of the shown embodiments of the invention may be combined with any other feature or features as long as there is not a conflict between these features.

### REFERENCE NUMERALS

1: A sensor, for example an accelerometer, that measures a parameter that relates to the condition of the machine that is being examined.

2: Input conditioning; providing sensor power and gain if required

3: Demodulation, typically some form of band limiting filters followed by demodulation (examples are enveloping, GSe). This may also include demodulating signals that are ultrasonic (SEE or Acoustic emissions)

4: Filtering to remove spurious out of band signals or time domain integration

5: Multiplexor to select straight, filtered or demodulated paths

6: Anti-alias for removal of out of band signals

7: An analogue to digital converter (ADC) to convert analogue signal into digital representation

7′: An ADC, control clock master

7″: An ADC, control clock slave

8: A digital signal processor (DSP) to perform digital processing, for example FFT

8′: A DSP, control clock slave

9: Amplifier to boost output from analogue signal path to levels required to drive a headphone

10: Headphones for user to listen into analogue signal

11: A DAC, driven from the DSP with a digital stream representing, in this embodiment, a desired audio output which drives a headphone amplifier and headphones

11′: A DAC, control clock slave

12: A wireless transmitter

13: A wireless receiver (which may be part of a peripheral device)

14: Strobe

15: Actuator

1. An off-line signal analyzer comprising:
an analogue to digital converter configured to convert analogue input signals to digital signals, the analog input signals having a phase,
a digital signal processor configured to perform digital processing on the digital signals from the analogue to digital converter and to provide an output, and
a digital to analogue converter configured to provide an analogue output signal derived from the output of the digital signal processor to an output.

2. The off-line signal analyzer in accordance with claim 1, wherein a signal phase of the digital to analogue converter is synchronized with a signal phase of the analogue to digital converter.

3. The off-line signal analyzer in accordance with claim 1, wherein the analogue to digital converter and the digital to analogue converter have a common control clock.

4. The off-line signal analyzer in accordance with claim 1, wherein the digital signal processor has a common control clock with one of the analogue to digital converter and the digital to analogue converter.

5. The off-line signal analyzer in accordance with claim 1, wherein one of the analogue to digital converter, the digital to analogue converter, and the digital signal processor is a control clock master and a remainder of the analogue to digital converter, the digital to analogue converter, and the digital signal processor are control clock slaves.

6. The off-line signal analyzer in accordance with claim 1, wherein the analogue output signal provided to the output includes a real time component.

7. The off-line signal analyzer in accordance claim 1, wherein the digital signal processor is arranged to provide the digital to analogue converter with digital signals such that the analogue output signal is configured to drive a peripheral device, the peripheral device being one of:
a listening device;
headphones;
an image recorder;
a camera;
a timing device;
a strobe light;
an actuator;
a frequency generator; and
a signal source for exciting a structure to be examined.

8. The off-line signal analyzer in accordance with claim 1, wherein the digital signal processor is arranged to provide the digital to analogue converter with digital signals such that the analogue output signal is configured to provide a feedback signal used as the analogue input signal of the off-line signal analyzer.

9. The off-line signal analyzer in accordance with claim 1, wherein the analogue output signal includes at least one of:
a signal configured to drive a listening device;
a signal configured to drive headphones;
a signal configured to control an image recorder;
a signal configured to control a camera;
a signal configured to control a timing device;
a signal configured to control a strobe light;
a signal configured to control an actuator;
a signal configured to control a frequency generator; and
a signal configured to control a signal source for exciting a structure to be examined.

10. The off-line signal analyzer in accordance with claim 1, wherein the output is configured to provide a signal to at least two different peripheral devices.

11. The off-line signal analyzer in accordance with claim 10, wherein the output is configured to simultaneously provide a signal to a least two different peripheral devices.

12. The off-line signal analyzer in accordance with claim 1, further comprising a selector configured to permit selection of the analogue output signal from at least two signals, each of the two signals being one of:
a signal configured to drive a listening device;
a signal configured to control an image recorder;
a signal configured to control a timing device;
a signal configured to control a strobe light; and
a signal configured to control a signal source for exciting a structure to be examined.

13. The off-line signal analyzer in accordance with claim 1, wherein the output includes a wireless transmitter configured to transmit a signal including the analogue signal.

14. The off-line signal analyzer in accordance with claim 1, wherein the analogue output signal is one of:
a signal representative of the input signal to the digital signal processor;
a signal digitally filtered by the digital signal processor;
a signal digitally filtered and demodulated by the digital signal processor;
a signal digitally attenuated by the digital signal processor;
a signal digitally amplified by the digital signal processor;
a signal shifted in frequency by the digital signal processor; and
a stereo signal having left and right channels providing different data.

15. The off-line signal analyzer in accordance with claim 1, further comprising a selector configured to permit selection of the analogue signal from at least two signals, the two signals each being one of:
a signal representative of the input signal to the digital signal processor;
a signal digitally filtered by the digital signal processor;
a signal digitally filtered and demodulated by the digital signal processor;
a signal digitally attenuated by the digital signal processor;
a signal digitally amplified by the digital signal processor;
a signal shifted in frequency by the digital signal processor;
a stereo signal having left and right channels providing different data; and
a pre-recorded signal.

16. The off-line signal analyzer in accordance with any claim 1, wherein the output is configured to output at least one of a plurality of analogue signals derived from the digital signal processor and selectable by a user.

17. The off-line signal analyzer in accordance with claim 1, wherein the analogue signal derived from the digital signal processor is configured to drive headphones.

18. The off-line signal analyzer in accordance with claim 1, wherein the output is configured to be controlled by a master, the master being one of:
the digital signal processor; and
an ADC which provides an input to the digital signal processor.
